(19) United States
(12) Patent Application Publication
(10) Pub. No.: US 2011/0157656 A1
(43) Pub. Date: Jun. 30, 2011

(54) SCANNER WITH REAL-TIME CALIBRATION

(76) Inventor: CHUN-CHIEH LIAO, Hsinchu City (TW)

(21) Appl. No.: 12/962,179

(22) Filed: Dec. 7, 2010

(30) Foreign Application Priority Data
Dec. 25, 2009 (TW) 098144956

(51) Int. Cl. H04N 1/04

(52) U.S. Cl. 358/406

(57) ABSTRACT

A scanner includes a reference backing member, a scanning module, a transmission mechanism and a processing module. The scanning module scans the reference backing member and an original including first and second documents. The transmission mechanism moves one of the original and the scanning module relatively to the other. The scanning module scans the reference backing member and the original and successively obtains a first reference image signal representative of an image of the reference backing member, a first image signal representative of an image of the first document, a second reference image signal representative of the image of the reference backing member and a second image signal representative of an image of the second document. The processing module, coupled to the scanning module, compensates the first and second image signals according to the first and second reference image signals, respectively, to obtain first and second resulting signals.

This application claims priority of No. 098144956 filed in Taiwan R.O.C. on Dec. 25, 2009 under 35 USC 119, the entire content of which is hereby incorporated by reference.

### BACKGROUND OF THE INVENTION

1. Field of the Invention

The present invention relates to a scanner with the real-time calibration, and more particularly to a flatbed document scanner or sheet-fed document scanner with the real-time calibration.

2. Related Art

A scanning module of a conventional document scanner has to scan a calibration sheet to obtain a calibration standard and then scan a document to obtain a scan result, which is compensated based on the calibration standard, such that the image quality is enhanced. For a sheet-fed document scanner, however, the scanning module only performs one calibration process before scanning a batch of documents. The quality of the scanned outputs of the first document and the last document of the batch may vary, since the system properties or the external environment gradually changes over time. For example, the luminance of the lamp may change over time, and, even with a slight change, the scan results of the documents will be affected.

Theoretically, it is presumed that the luminance of the lamp remains constant after the document scanner has been activated or during the course of scanning a batch of documents. However, this presumption cannot satisfy the increasingly stringent requirements on the scan quality.

### SUMMARY OF THE INVENTION

Accordingly, the present invention has been proposed to solve the problems of the prior art, and it is an object of the present invention to provide a document scanner with the real-time calibration by utilizing the gaps between documents.

To achieve the above-identified object, the present invention provides a scanner with the real-time calibration. The scanner includes a reference backing member, a scanning module, a transmission mechanism and a processing module. The scanning module, disposed opposite the reference backing member, scans the reference backing member and an original comprising a first document and a second document. The transmission mechanism moves one of the original and the scanning module relatively to the other, wherein the scanning module scans the reference backing member and the original and successively obtains a first reference image signal representative of an image of the reference backing member, a first image signal representative of an image of the first document, a second reference image signal representative of the image of the reference backing member, and a second image signal representative of an image of the second document. The processing module, coupled to the scanning module, receives the first reference image signal, the first image signal, the second reference image signal and the second image signal, compensates the first image signal according to the first reference image signal to obtain a first resulting signal, and compensates the second image signal according to the second reference image signal to obtain a second resulting signal.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a scanner with the real-time calibration according to a first embodiment of the present invention.

FIG. 2 is a partially schematic illustration showing a scanner according to a second embodiment of the present invention.

FIG. 3 is a schematic illustration showing a flatbed document scanner with the real-time calibration according to a third embodiment of the present invention.

FIGS. 4 and 5 show two implementations of scanning the original according to the present invention.

### DETAILED DESCRIPTION OF THE INVENTION

The present invention will be apparent from the following detailed description, which proceeds with reference to the accompanying drawings.

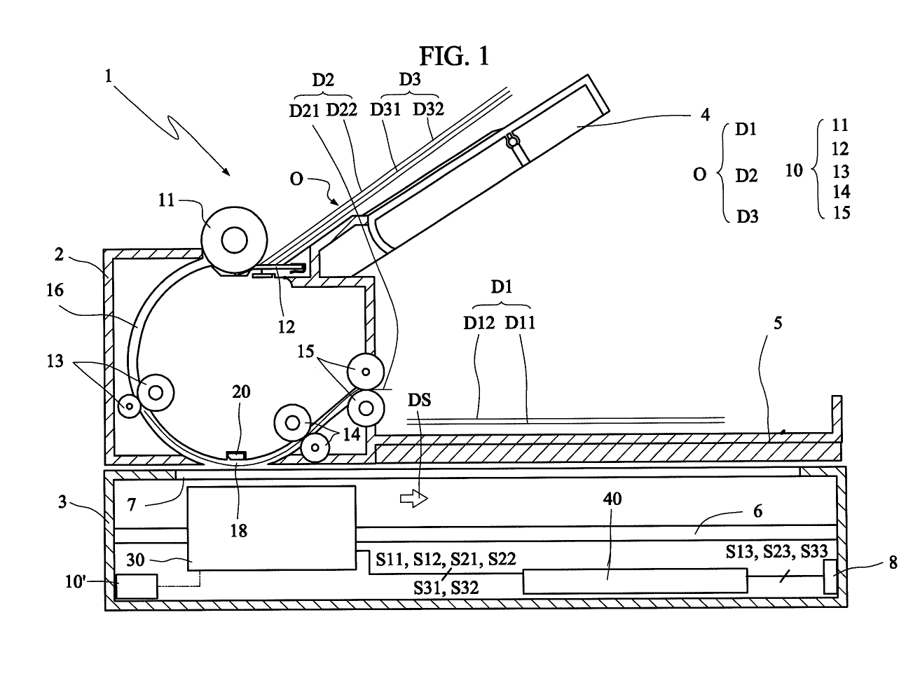

FIG. 1 is a schematic illustration showing a scanner 1 with the real-time calibration according to a first embodiment of the present invention. Referring to FIG. 1, the scanner 1 includes a reference backing member 20, a scanning module 30, transmission mechanisms 10 and 10′ and a processing module 40. In addition, the scanner 1 further includes an upper housing 2, a lower housing 3, a supply tray 4, an upper cover 5, a guiding rod 6, a transparent platen 7 and an output port 8. The transmission mechanism 10 is mounted in the upper housing 2, and the transmission mechanism 10′ is mounted in the lower housing 3. The supply tray 4, mounted on the upper housing 2, supports a plurality of sheets. The upper cover 5 is disposed opposite the transparent platen 7, and the transmission mechanism 10′ drives the scanning module 30 to move back and forth along the guiding rod 6. The output port 8 is connected to the processing module 40 and to be connected to an electronic apparatus, such as a computer.

The reference backing member 20 is, for example, a calibration sheet, a white calibration member, a colored calibration member, a black-and-white calibration sheet, a colored calibration sheet, or a calibration sheet with marks, for calibrating the luminance of the light source or the characteristics of the scanning module. In this case, the reference backing member 20 is stationary relatively to the scanning module 30.

The scanning module 30, disposed opposite the reference backing member 20, scans the reference backing member 20 and an original O including a first document D1 and a second document D2. Each of the first document D1 and the second document D2 may contain one single page or multiple pages. That is, the first document D1 contains only one first sheet, such as D11, and the second document D2 contains only one second sheet, such as D21. In another example, the first document D1 may contain a first sheet and a second sheet, such as D11 and D12, and the second document D2 may contain a third sheet and a fourth sheet, such as D21 and D22.

The scanning module 30 may include a charge-coupled device (CCD) type image sensor or a contact type image sensor (CIS). In a sheet-fed document scanner, the scanning module 30 may be completely stationary. In a flatbed document scanner, the scanning module 30 is movable disposed.

The transmission mechanism 10 moves one of the original O and the scanning module 30 relatively to the other, wherein the scanning module 30 scans the reference backing member 20 and the original O and successively obtains a first reference image signal S11 representative of an image of the reference backing member 20, a first image signal S12 representative of an image of the first document D1, a second reference image signal S21 representative of the image of the reference backing member 20, and a second image signal S22 representative of an image of the second document D2. In the sheet-fed document scanner, for example, the transmission mechanism 10 is a sheet-feeding mechanism for transporting the original O past the scanning module 30 to generate a scanned image of the original O. For example, the transmission mechanism 10 includes a sheet-input roller 11, a friction pad 12 and a plurality of transporting rollers 13, 14 and 15 for transporting the sheet along a sheet passageway 16 past a scan region 18, in which the scanning module 30 scans the sheet. In the flatbed document scanner, the transmission mechanism 10′ moves the scanning module 30.

The processing module 40, coupled to the scanning module 30, receives the first reference image signal S11, the first image signal S12, the second reference image signal S21 and the second image signal S22. Next, the processing module 40 compensates the first image signal S12 according to the first reference image signal S11 to obtain a first resulting signal S13, and compensates the second image signal S22 according to the second reference image signal S21 to obtain a second resulting signal S23.

In another example, the processing module 40 compensates the second image signal S22 according to the first reference image signal S11 and the second reference image signal S21 to obtain the second resulting signal S23.

In addition, the original O may further include a third document D3, which contains sheets D31 and D32. In this case, the scanning module 30 further generates a third reference image signal S31 representative of the image of the reference backing member 20, and a third image signal S32 representative of an image of the third document D3. In addition, the processing module 40 further receives the third reference image signal S31 and the third image signal S32. The processing module 40 can compensate the third image signal S32 according to the first reference image signal S11 and the third reference image signal S31 to obtain a third resulting signal S33. In another example, the processing module 40 compensates the third image signal S32 according to the second reference image signal S21 and the third reference image signal S31 to obtain the third resulting signal S33.

The timings of calibration can be determined according to various judgement rules because the physical attenuation properties of light sources of various scanners with respect to time are not consistent with one another. In one example, the processing module 40 determines the number of sheets of the first document D1 according to a time length. For example, the processing module 40 requires 60 seconds for scanning one sheet. The processing module 40 determines the number of sheets (10 or 20 sheets) that can be scanned in the time length of 10 or 20 minutes, and the calibration process is performed before the 11^{th} or 21^{st} sheet is scanned. This time length may be set before the product is shipped out, or may be set by the user.

In another example, the processing module 40 determines the number of sheets of the first document D1 according to a user input, such as 10 or 20, and then accordingly determines the time for calibration.

When the first document D1 contains the sheet D11 and the sheet D12, the first image signal S12 contains the image signals representative of the images of the sheet D11 and the sheet D12. In addition, the first image signal S12 may further include a plurality of image signals corresponding to the reference backing member 20.

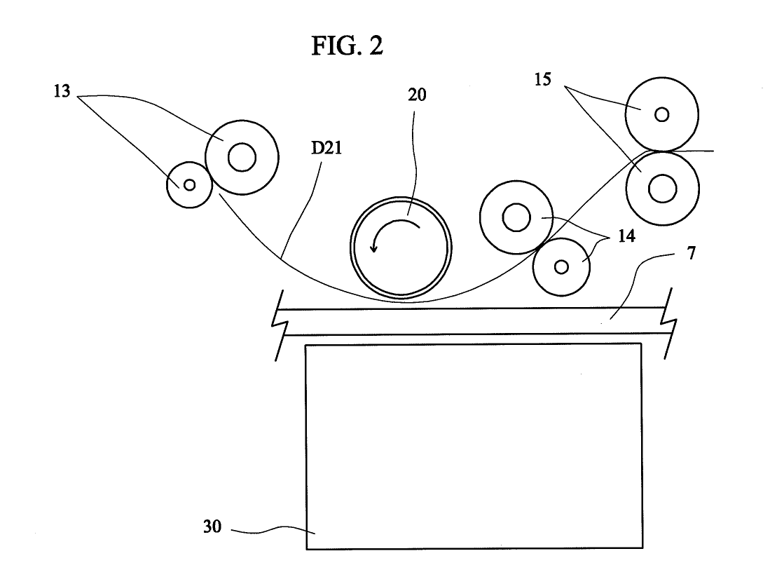

FIG. 2 is a partially schematic illustration showing a scanner according to a second embodiment of the present invention. As shown in FIG. 2, the reference backing member 20 may also be attached to a rotatable roller or may be configured as a rotatable cylinder. In this case, the reference backing member 20 is rotatable relatively to the scanning module 30.

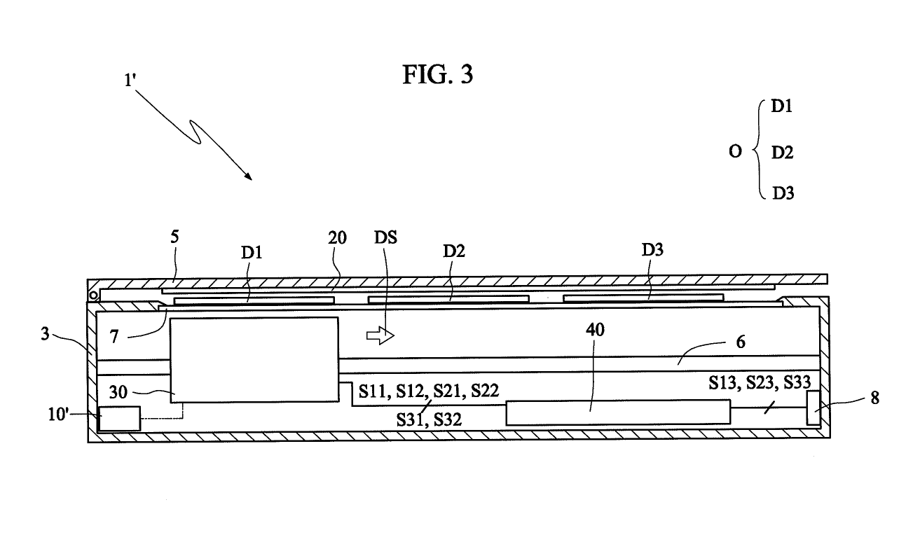

FIG. 3 is a schematic illustration showing a flatbed document scanner with the real-time calibration according to a third embodiment of the present invention. As shown in FIG. 3, the scanner is similar to that of FIG. 1 except that the scanner is a flatbed document scanner 1′ having a transmission mechanism 10′ for moving the scanning module 30 to scan the original O in a scan direction DS.

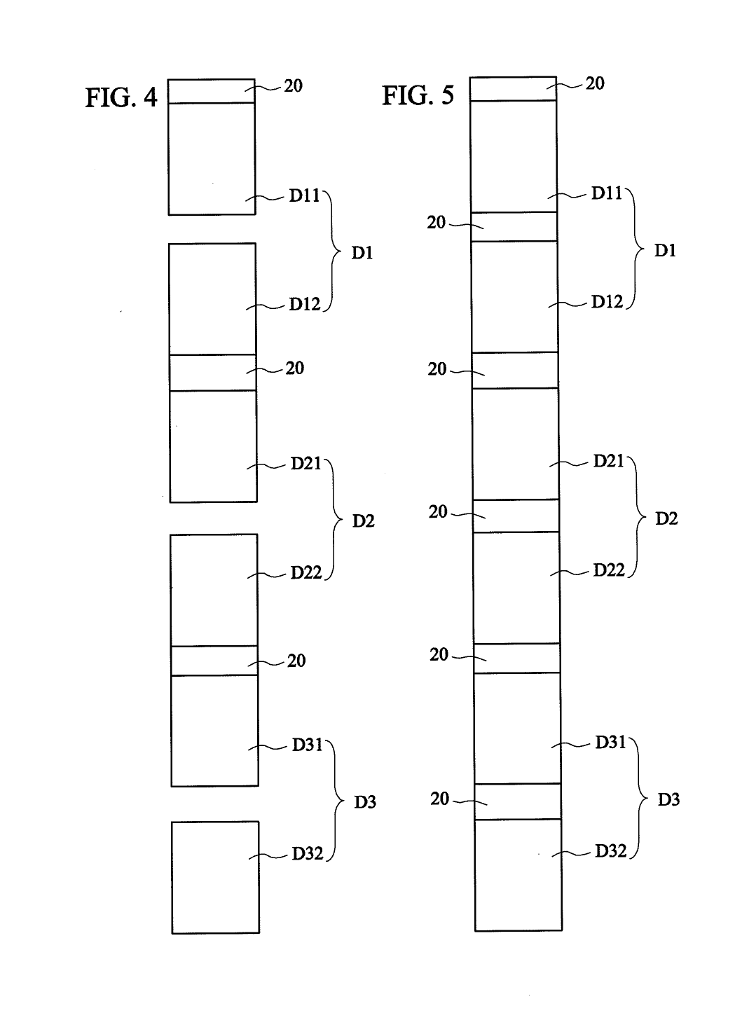

FIGS. 4 and 5 show two implementations of scanning the original according to the present invention. As shown in FIG. 4, the scanning module 30 scans the reference backing member 20 to perform the calibration process after two sheets have been scanned. As shown in FIG. 5, the scanning module 30 scans the reference backing member 20 to perform the calibration process after one single sheet is scanned. It is to be noted that the timings of scanning the reference backing member 20 may be determined according to various requirements, as mentioned hereinabove.

In the scanner of the present invention, the reference backing member present in the gap between any two sheets is scanned as a reference for compensating the scanned image of the next sheet, and the calibration process may also be performed by using the blank sections of the two sheets. Thus, high image quality is maintained. This method can be applied to not only the sheet-fed document scanner but also the flatbed document scanner. When the sheet-fed document scanner scans over 100 pages of documents or scans two pages of a document in a high-resolution color mode, or when the flatbed document scanner scans more than two pages of a document in the high-resolution color mode, the real-time calibration can be carried out by utilizing the scanned image of the reference backing member between any two consecutive sheets.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A scanner, comprising:
a reference backing member;
a scanning module, disposed opposite the reference backing member, for scanning the reference backing member and an original comprising a first document and a second document;
a transmission mechanism for moving one of the original and the scanning module relatively to the other, wherein the scanning module scans the reference backing member and the original and successively obtains a first reference image signal representative of an image of the reference backing member, a first image signal representative of an image of the first document, a second reference image signal representative of the image of the reference backing member, and a second image signal representative of an image of the second document; and
a processing module, coupled to the scanning module, for receiving the first reference image signal, the first image signal, the second reference image signal and the second image signal, compensating the first image signal according to the first reference image signal to obtain a first resulting signal, and compensating the second image signal according to the second reference image signal to obtain a second resulting signal.

2. The scanner according to claim 1, wherein the processing module compensates the second image signal according to the first reference image signal and the second reference image signal to obtain the second resulting signal.

3. The scanner according to claim 1, wherein,
the original further comprises a third document;
the scanning module further generates a third reference image signal representative of the image of the reference backing member and a third image signal representative of an image of the third document; and
the processing module further receives the third reference image signal and the third image signal.

4. The scanner according to claim 3, wherein the processing module compensates the third image signal according to the first reference image signal and the third reference image signal to obtain a third resulting signal.

5. The scanner according to claim 3, wherein the processing module compensates the third image signal according to the second reference image signal and the third reference image signal to obtain a third resulting signal.

6. The scanner according to claim 1, wherein the first document contains only one first sheet, and the second document contains only one second sheet.

7. The scanner according to claim 1, wherein the first document comprises a first sheet and a second sheet, and the second document comprises a third sheet and a fourth sheet.

8. The scanner according to claim 7, wherein the processing module determines the number of sheets of the first document according to a time length.

9. The scanner according to claim 7, wherein the processing module determines the number of sheets of the first document according to a predetermined value.

10. The scanner according to claim 7, wherein the first image signal comprises an image signal representative of an image of the first sheet and an image signal representative of an image of the second sheet.

11. The scanner according to claim 10, wherein the first image signal further comprises a plurality of image signals each representative of the image of the reference backing member.

12. The scanner according to claim 1, wherein the reference backing member is stationary relatively to the scanning module.

13. The scanner according to claim 1, wherein the reference backing member is rotatable relatively to the scanning module.

14. The scanner according to claim 1 being a sheet-fed document scanner.

15. The scanner according to claim 14, wherein the transmission mechanism moves the original to be scanned by the scanning module.

16. The scanner according to claim 1 being a flatbed document scanner.

17. The scanner according to claim 16, wherein the transmission mechanism moves the scanning module to scan the original in a scan direction.
